(19) United States
(12) Patent Application Publication
(10) Pub. No.: US 2016/0291750 A1
(43) Pub. Date: Oct. 6, 2016

(54) ARRAY SUBSTRATE AND LIQUID CRYSTAL DISPLAY PANEL

(71) Applicants: Shanghai Tianma Micro-Elctronics Co., Ltd., Shanghai (CN); Tianma Micro-Electronics Co., Ltd., Shenzhen (CN)

(72) Inventors: Huiping CHAI, Shanghai (CN); Yong YUAN, Shanghai (CN)

(21) Appl. No.: 14/794,683

(22) Filed: Jul. 8, 2015

(30) Foreign Application Priority Data
Apr. 1, 2015 (CN) 201510152693.0

(51) Int. Cl. G06F 3/041; G02F 1/1343; G02F 1/1368; G02F 1/1362; G06F 3/047; G02F 1/1333

(52) U.S. Cl. CPC G06F 3/0412; G06F 3/047; G02F 1/13338; G02F 1/1368; G02F 1/136286; G02F 1/134309; G02F 1/133345

(57) ABSTRACT

An array substrate and a liquid crystal display panel are provided. The array substrate includes: multiple thin film transistors arranged in an array; a first flat layer on the multiple thin film transistors; a touch wire layer arranged on the first flat layer, where the touch wire layer includes multiple touch wires; and a second flat layer arranged on the touch wire layer. The array substrate addresses issues of an uneven surface of the film layer due to the arrangement of the touch wires in the touch wire layer, thereby eliminating negative effects on subsequent processes due to the arrangement of the touch wires. The touch wires are arranged between two flat layers, and an insulating layer adjacent to the touch wire layer is omitted. Only one insulating layer is arranged between the common electrode and the pixel electrode.

### CROSS-REFERENCES TO RELATED APPLICATIONS

This application claims the benefit of priority to Chinese Patent Application No. 201510152693.0, filed with the Chinese Patent Office on Apr. 1, 2015 and entitled “ARRAY SUBSTRATE AND LIQUID CRYSTAL DISPLAY PANEL”, the content of which is incorporated herein by reference in its entirety.

### BACKGROUND OF THE INVENTION

1. Field

The disclosure relates to the technical field of liquid crystal displays, and in particular, to an array panel and a liquid crystal display panel.

2. Background

A main body of a current liquid crystal display panel includes a color film substrate and an array substrate. The flatness of a surface pattern of the array substrate is sought in the fabrication process to avoid problems in subsequent processes. Therefore, a flat layer is arranged on a surface of the array substrate.

Touch wires are used in a liquid crystal display panel integrated with a touch function. The touch wires are used for connecting each of the touch electrodes to a touch driver chip. The touch electrodes are generally arranged in a different layer from the touch wires, and each of the touch wires is electrically connected to a corresponding touch electrode through a via hole. It should be noted that, in the liquid crystal display panel integrated with a touch function, the touch electrode and a common electrode may be the same electrode, or may be arranged separately.

In conventional technology, touch wires are generally arranged on the flat layer in the liquid crystal display panel integrated with a touch function. The flat layer is arranged on a data line layer, the touch wires are arranged on the flat layer, a first insulating layer is arranged on the touch wires, a common electrode layer is arranged on the first insulating layer, a second insulating layer is arranged on the common electrode layer, and a pixel electrode layer is arranged on the second insulating layer.

Compared with a liquid crystal display panel integrated with no touch function, the touch wires are arranged on a side of a substrate of the thin film transistor in the liquid crystal display panel integrated with a touch function. Therefore, a film layer arranged on the touch wires has an uneven surface, which may significantly affect a subsequent rubbing effect, thereby resulting in an issue of light leakage.

Hence, it is required to provide a liquid crystal display apparatus and an electronic device by those skilled in the art, to address issues of an uneven surface of an array substrate when touch wires are formed, the uneven surface may adversely affect the array substrate in subsequent processes.

### BRIEF SUMMARY OF THE INVENTION

An array substrate and a liquid crystal display panel are provided according to embodiments of the present disclosure, to address issues that a film layer arranged on touch wires has an uneven surface due to arrangement of the touch wires, thereby eliminating harmful effects on the subsequent process due to the arrangement of the touch wires.

An embodiment of the present disclosure provides an array substrate, which includes:

multiple thin film transistors arranged in an array, where each of the thin film transistors includes a gate, a source and a drain;

a first flat layer covering on the multiple thin film transistors;

a touch wire layer arranged on the first flat layer, where the touch wire layer includes multiple touch wires; and

a second flat layer arranged on the touch wire layer.

An embodiment of the present disclosure also provides a liquid crystal display panel, which includes the above-described array substrate, a color film substrate arranged opposite to the array substrate, and a liquid crystal layer arranged between the array substrate and the color film substrate.

Compared with conventional technology, the present disclosure has the following advantages.

A structure of the array substrate is optimized in the present disclosure. Specifically, two flat layers are arranged, where a first flat layer is arranged on the thin film transistor, and a second flat layer is arranged on the touch wire layer. Accordingly, the following issues may be addressed that the film layer arranged on the touch wires has an uneven surface due to the arrangement of the touch wires in the touch wire layer, thereby eliminating harmful effects on subsequent processes due to the arrangement of the touch wires. Moreover, an insulating layer adjacent to the touch wire layer in the conventional technology may be omitted since the touch wires are arranged between the first flat layer and the second flat layer. In the conventional technology, one insulating layer is arranged between the touch wire layer and the common electrode layer, and one insulating layer is arranged between the common electrode and the pixel electrode, whereas only one insulating layer is arranged between the common electrode and the pixel electrode according to the present disclosure. Therefore, in such array substrate according to embodiments of the present invention, one insulating layer is omitted compared with the conventional technology, and thus a process of chemical vapor deposition for one insulating layer may be omitted correspondingly. Moreover, one flat layer is arranged on the touch wires, and thus the flatness of a surface on the touch wires may be improved, and the issues of rubbing and light leakage may be addressed. The touch wires may be thicker since the touch wires are arranged between two flat layers, thereby reducing the entire resistance of the touch wires.

### BRIEF DESCRIPTION OF THE DRAWINGS

The drawings needed to be used in the description of embodiments or the conventional technology are described briefly as follows, so that technical solutions according to the embodiments of the present disclosure or according to the conventional technology may become clearer. It is obvious that the drawings in the following description only illustrate some embodiments of the present disclosure. For those skilled in the art, other drawings may be obtained based on these drawings without any creative work.

FIG. 1 is a sectional view of an array substrate according to an embodiment of the present disclosure;

FIG. 2 is a sectional view of an array substrate according to another embodiment of the present disclosure;

FIG. 3 is a sectional view of an array substrate according to still another embodiment of the present disclosure;

FIG. 4 is a sectional view of an array substrate according to yet another embodiment of the present disclosure;

FIG. 5 is a sectional view of an array substrate according to still yet another embodiment of the present disclosure;

FIG. 6 is a sectional view of a display panel according to the present disclosure; and

FIG. 7 is a schematic view of an electronic device according to the present disclosure.

### DETAILED DESCRIPTION OF THE INVENTION

Technical solutions according to embodiments of the present disclosure are described clearly and completely hereinafter in conjunction with the drawings. It is obvious that the described embodiments are only a part rather than all of the embodiments according to the present disclosure. Any other embodiments obtained by those skilled in the art based on the embodiments in the present disclosure without any creative work fall in the scope of the present disclosure.

To make the above objects, features and advantages of the present disclosure more apparent and easy to be understood, particular embodiments of the disclosure are illustrated in detail in conjunction with the drawings hereinafter.

### First Embodiment

An array substrate according to the embodiment of the present disclosure includes:

multiple thin film transistors (abbreviated as TFT) arranged in an array, where each of the thin film transistors includes a gate, a source and a drain;

a first flat layer covering on the multiple thin film transistors;

a touch wire layer arranged on the first flat layer, where the touch wire layer includes multiple touch wires; and

a second flat layer arranged on the touch wire layer.

It should be noted that the first flat layer and the second flat layer according to the embodiment of the present disclosure function as planarization, and may be made of an organic film. In a typical fabrication method, the organic film is liquefied and then solidified onto the flattened film layer, and a required pattern is formed by means of a lithography process. It is to be understood that the flat layer does not equivalent to an insulating layer in the conventional technology although the flat layer has a function of insulation. There is an essential difference on materials of the flat layer and the insulating layer, for example, the insulating layer is generally made of silicon nitride and silicon oxide. Additionally, there is an essential difference between the processes for forming the flat layer and the insulating layer. The insulating layer is generally formed by means of a chemical vapor deposition (abbreviated as CVD), a lithography process and an etching process are combined, and thus a final pattern can be formed.

A structure of the array substrate is optimized in the present disclosure. Specifically, two flat layers are arranged, where a first flat layer is arranged on the thin film transistor, and a second flat layer is arranged on the touch wire layer. Accordingly, the following issues are addressed that the film layer arranged on the touch wires has an uneven surface due to arrangement of the touch wires in the touch wire layer, thereby eliminating harmful effects on subsequent process due to the arrangement of the touch wires. Moreover, an insulating layer adjacent to the touch wire layer in the conventional technology may be omitted since the touch wires are arranged between the first flat layer and the second flat layer. In the conventional technology, one insulating layer is arranged between the touch wire layer and the common electrode layer, and one insulating layer is arranged between the common electrode and the pixel electrode, whereas only one insulating layer is arranged between the common electrode and the pixel electrode according to the present disclosure. Therefore, in such array substrate according to the embodiment, one insulating layer is omitted compared with the conventional technology, and thus a process of chemical vapor deposition for one insulating layer may be omitted correspondingly, and an etching process may be omitted.

In such array substrate according to the embodiment, one flat layer is arranged on the touch wires, and thus the flatness of a surface on the touch wires may be improved, and the issues of rubbing and light leakage may be addressed. The touch wires may be made thicker since the touch wires are arranged between two flat layers, thereby reducing the entire resistance of the touch wires.

Taking a case of top-com where the common electrode is arranged on the top surface of the array substrate and a case of mid-com where the common electrode is arranged in the middle of the array substrate as examples. Embodiments of the array substrates are illustrated as follows.

### Second Embodiment

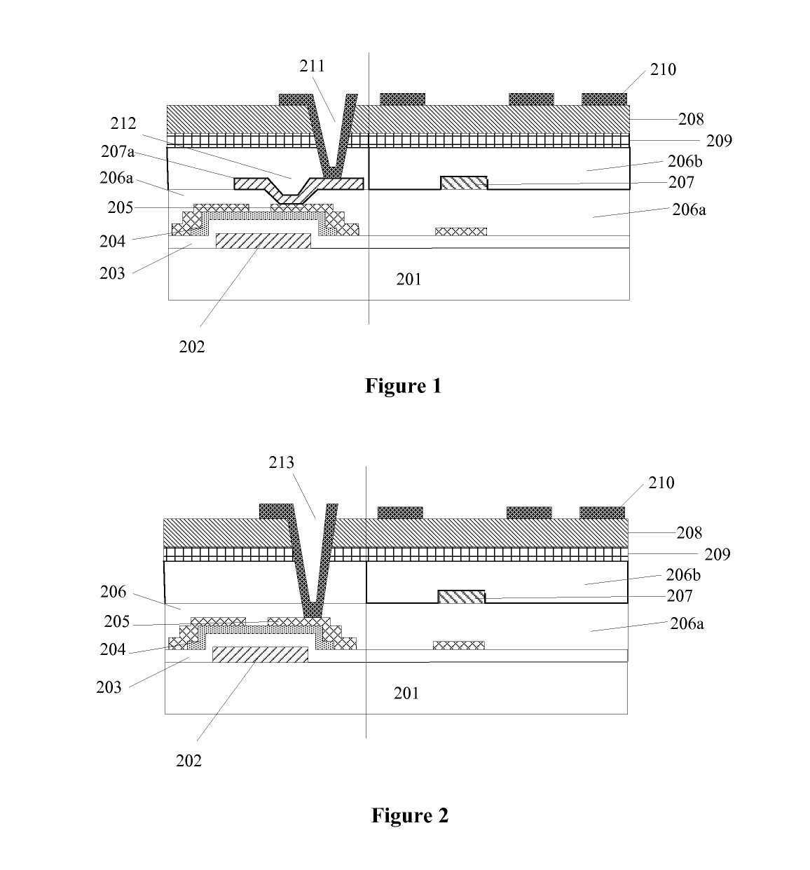

Referring to FIG. 1, FIG. 1 is a sectional view of an array substrate according to an embodiment of the present disclosure.

The array substrate according to the embodiment includes: a substrate 201, a gate 202, a gate insulating layer 203, a conductor layer 204, a first insulating layer 208, a pixel electrode layer 210, and a common electrode layer 209.

The common electrode layer 209 is arranged on a second flat layer 206b and includes multiple touch electrodes independent of each other, and each of the touch electrodes is connected to one or more of the touch wires 207.

The first insulating layer 208 is arranged on the common electrode layer 209.

The pixel electrode layer 210 is arranged on the first insulating layer 208.

The array substrate further includes a metal gasket 207a arranged on a first flat layer 206a, and the metal gasket 207a is arranged in the same layer with the touch wires 207.

A first via hole 212 passing through the first flat layer 206a is arranged above the drain 205 of the thin film transistor, and the metal gasket 207a is connected to the drain 205 of the thin film transistor through the first via hole 212.

A second via hole 211 passing through the second flat layer 206b is arranged above the metal gasket 207a, and the pixel electrode layer 210 is connected to the metal gasket 207a through the second via hole 211.

It is to be understood that a connection between the pixel electrode and the drain of the thin film transistor is spaced and conducted via the metal gasket, which may address the issue that the metal gasket remains in a via hole, and may optimize the contact resistance between the pixel electrode and the drain of the thin film transistor.

It should be noted that the first flat layer 206a and the second flat layer 206b are made of organic insulating material. Preferably, the first flat layer 206a and the second flat layer 206b are organic film layers. The second flat layer 206b is not prone to be broken (resistant to breakage) since the second flat layer 206b has a substantial thickness, and thus the second flat layer 206b has a better coverage of the touch wires 207. Moreover, the second flat layer 206b may be thicker than the insulating layer in the conventional technology since the second flat layer 206b is arranged between the touch wires 207 and the common electrode 209. Therefore, the parasitic capacitance between the touch wires 207 and the common electrode 209 may be reduced significantly, and the touch sensitivity may be improved.

It can be understood that a projection of the first via hole 212 onto the array substrate is overlapped with a projection of the second via hole 211 onto the array substrate. In other words, the projection area of the first via hole 212 on the array substrate is overlapped with the projection area of the second via hole 211 on the array substrate.

In the embodiment corresponding to FIG. 1, a projection of the first via hole 212 onto the array substrate is staggered with respect to a projection of the second via hole 211 onto the array substrate.

An active layer of the thin film transistor is made of amorphous silicon (a-Si) or low temperature polysilicon (Low Temperature p-Si, abbreviated as LTPS).

As shown in FIG. 1, the thin film transistor includes the gate 202, and the gate insulating layer 203 is arranged on the gate 202; the conductor layer 204 is arranged on the gate insulating layer 203, and the source and the drain are arranged on the conductor layer 204.

It should be noted that, in the embodiment corresponding to FIG. 1, the metal gasket 207a is connected to the drain 205 of the thin film transistor through the first via hole 212, and the pixel electrode layer 210 is connected to the metal gasket 207a through the second via hole 211. Accordingly, the pixel electrode layer 210 and the drain 205 of the thin film transistor are connected indirectly. In this case, two via holes are arranged, and a depth of each of the via holes is shallow, and thus the manufacturing process is simplified.

### Third Embodiment

Reference is made to FIG. 2, this embodiment differs from the embodiment corresponding to FIG. 1 in that the drain of the thin film transistor is indirectly electrically connected to the pixel electrode layer through two via holes in the embodiment corresponding to FIG. 1, and the drain of the thin film transistor is directly electrically connected to the pixel electrode layer through one via hole in this embodiment. In a case that an electrical connection is achieved through one via hole, a through depth of the via hole is needed to be deep, and the manufacturing process is complex.

As shown in FIG. 2, a third via hole 213 passing through the first flat layer 206a and the second flat layer 206b is arranged above the drain 205 of the thin film transistor, and the pixel electrode layer 210 is connected to the drain 205 of the thin film transistor through the third via hole 213 in the embodiment.

### Fourth Embodiment

The case of top-com is illustrated below.

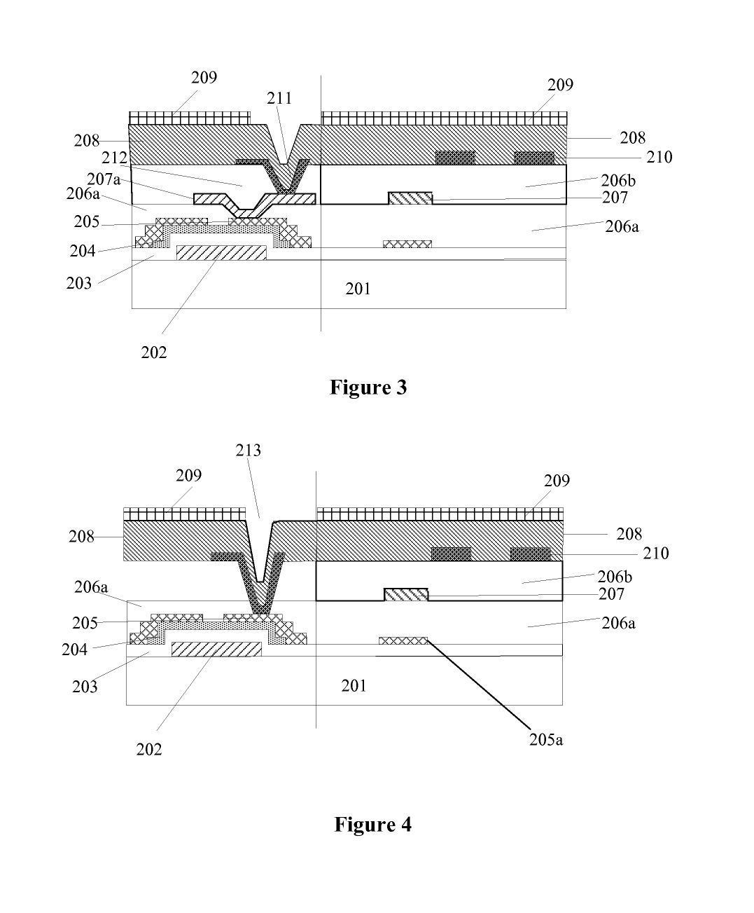

Referring to FIG. 3, FIG. 3 is a sectional view of an array substrate according to an embodiment of the present disclosure.

The array substrate according to the embodiment includes: a first insulating layer 208, a pixel electrode layer 210 and a common electrode layer 209.

The pixel electrode layer 210 is arranged on the second flat layer 206b.

The first insulating layer 208 is arranged on the pixel electrode layer 210.

The common electrode layer 209 is arranged on the first insulating layer 208 and includes multiple touch electrodes independent of each other, and each of the touch electrodes is connected to one or more of the touch wires 207.

In the array substrate according to the embodiment, the common electrode layer 209 is arranged at the top. In the conventional technology, one insulating layer is arranged between the touch wire layer and the common electrode layer and one insulating layer is arranged between the common electrode and the pixel electrode. In the present disclosure, only one insulating layer 208 is arranged between the common electrode layer 209 and the pixel electrode layer 210. Therefore, in the array substrate according to the embodiment, one insulating layer adjacent to the touch wire layer is omitted compared with the conventional technology, and the touch wires are arranged between two insulating layers. Hence, the issues in the conventional technology that the film layer arranged on the touch wires has an uneven surface are addressed.

Moreover, the common electrode according to the embodiment has a structure of top-com and there is only one insulating layer. Therefore, the insulating layer may be thicker, thereby reducing the parasitic capacitance between the touch wires and the common electrode.

The parasitic capacitance between the touch wires and the touch electrode may be reduced since the touch electrode serves as the common electrode.

### Fifth Embodiment

Reference is still made to FIG. 3.

The array substrate according to the embodiment includes a metal gasket 207a arranged in the same layer with the touch wire 207.

The metal gasket 207a is arranged on the first flat layer 206a, and the metal gasket 207a is arranged in the same layer with the touch wires 207.

A first via hole 212 passing through the first flat layer 206a is arranged above the drain 205 of the thin film transistor, and the metal gasket 207a is connected to the drain 205 of the thin film transistor through the first via hole 212.

A second via hole 211 passing through the second flat layer 206b is arranged above the metal gasket 207a, and the pixel electrode layer 210 is connected to the metal gasket 207a through the second via hole 211.

As shown in FIG. 3, the thin film transistor includes a gate 202, a gate insulating layer 203 is arranged on the gate 202; a conductor layer 204 is arranged on the gate insulating layer 203, and the source and the drain are arranged on the conductor layer 204 on opposite sides of the conductor layer 204.

It should be noted that, the metal gasket 207a is connected to the drain 205 of the thin film transistor through the first via hole 212, and the pixel electrode layer 210 is connected to the metal gasket 207a through the second via hole 211 in the embodiment. Accordingly, the pixel electrode layer 210 and the drain 205 of the thin film transistor are electrically connected indirectly. In this case, two via holes are arranged, and a depth of each of the via holes is shallow, and thus the process technology is simplified.

### Sixth Embodiment

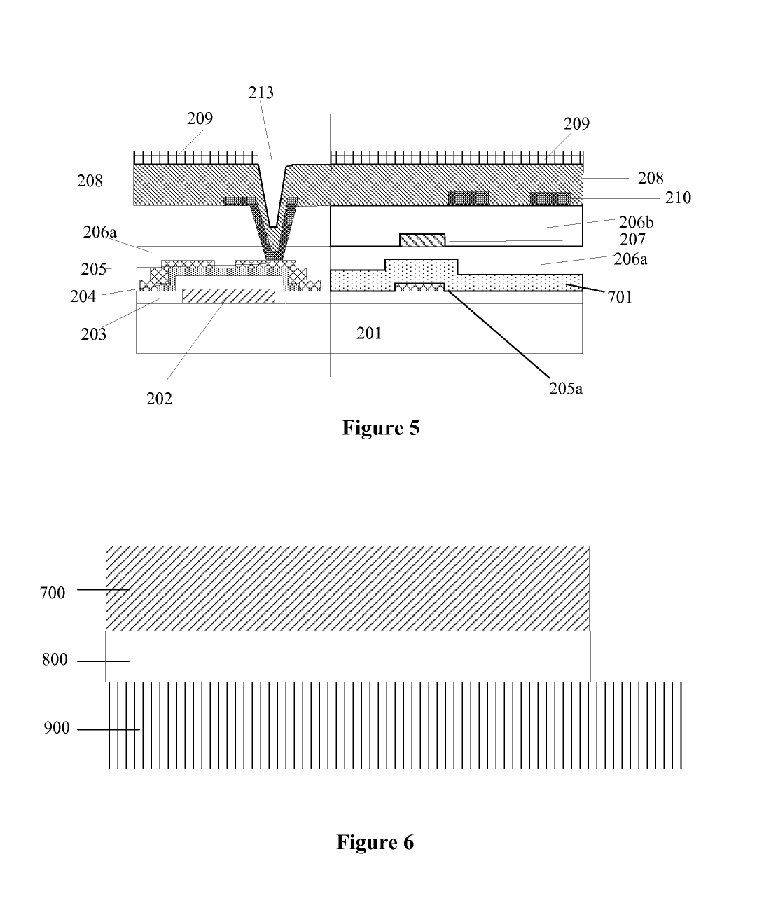

Reference is made to FIG. 4, this embodiment differs from the embodiment corresponding to FIG. 3 in that the drain of the thin film transistor is indirectly electrically connected to the pixel electrode layer through two via holes in the embodiment corresponding to FIG. 3, and the drain of the thin film transistor is directly electrically connected to the pixel electrode layer through one via hole in this embodiment. In a case that an electrical connection is achieved through one via hole, a through depth of the via hole is needed to be deep, and the process is complex.

As shown in FIG. 4, a third via hole 213 passing through the first flat layer 206a and the second flat layer 206b is arranged above the drain 205 of the thin film transistor, and the pixel electrode layer 210 is connected to the drain 205 of the thin film transistor through the third via hole 213 in the embodiment.

It should be noted that, the array substrate according to the embodiment of the present disclosure may further include a second insulating layer 701, as shown in FIG. 5. The second insulating layer 701 is added in FIG. 5 on a basis of FIG. 4.

The second insulating layer 701 is arranged between the first flat layer 206a and the data line layer, and the second insulating layer 701 may be made of silicon nitride.

It should be noted that the source and the drain 205 of the thin film transistor and the data line 205a are arranged in the data line layer.

It should be noted that, in the array substrate according to the above embodiments of the present disclosure, preferably, the first flat layer may have a thickness ranging from 0.5 μm to 6 μm, and the second flat layer may have a thickness ranging from 0.5 μm to 6 μm.

A liquid crystal display panel is further provided according to an embodiment of the present disclosure. Referring to FIG. 6, the liquid crystal display panel includes an array substrate 900 according to any one of the above embodiments, a color film substrate 700 arranged opposite to the array substrate 900, and a liquid crystal layer 800 is arranged between the array substrate 900 and the color film substrate 700.

It should be noted that in the display panel according to the above embodiment, a liquid crystal driving mode for the display panel is an in plane switching (abbreviated as IPS) mode; or a liquid crystal driving mode for the display panel is a fringe filed switching (abbreviated as FFS) mode.

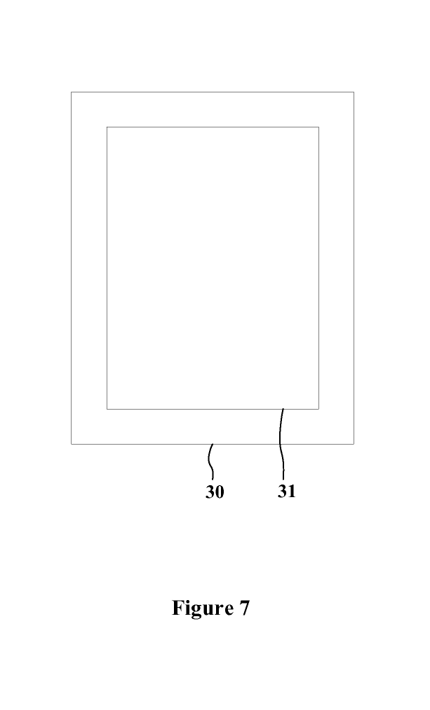

An electronic device is provided according to an embodiment of the present disclosure. Referring to FIG. 7, the electronic device includes the display panel according to any one of the above embodiments.

The electronic device 30 includes a display panel 31, a driver circuit and other components for the operation of the electronic device 30.

The display panel 31 is the display panel according to the above embodiments. The electronic device 30 may be one of a mobile phone, a desktop computer, a notebook computer, a tablet computer, and an electronic paper.

What is described above is only preferred embodiments of the present disclosure and is not intended to limit the present disclosure in any way. The preferred embodiments of the present disclosure are disclosed above, which should not be interpreted as limiting the present disclosure. Numerous alternations, modifications, and equivalents can be made to the technical solutions of the present disclosure by those skilled in the art in light of the methods and technical content disclosed herein without deviation from the scope of the present disclosure. Therefore, any alternations, modifications, and equivalents made to the embodiments above according to the technical essential of the present disclosure without deviation from the scope of the present disclosure should fall within the scope of protection of the present disclosure.

What is claimed is:

1. An array substrate, comprising:
a plurality of thin film transistors, each of the plurality of thin film transistors comprising a gate, a source and a drain;
a first flat layer on the plurality of thin film transistors;
a touch wire layer on the first flat layer and comprising a plurality of touch wires; and
a second flat layer on the touch wire layer.

2. The array substrate according to claim 1, further comprising: a first insulating layer, a pixel electrode layer, and a common electrode layer,
wherein the common electrode layer is arranged on the second flat layer and comprises a plurality of touch electrodes independent of each other, and each of the plurality of touch electrodes is connected to one or more of the plurality of touch wires;
the first insulating layer is arranged on the common electrode layer; and
the pixel electrode layer is arranged on the first insulating layer.

3. The array substrate according to claim 1, further comprising: a first insulating layer, a pixel electrode layer, and a common electrode layer,
wherein the pixel electrode layer is arranged on the second flat layer;
the first insulating layer is arranged on the pixel electrode layer; and
the common electrode layer is arranged on the first insulating layer and comprises a plurality of independent touch electrodes, each of the plurality of touch electrodes being connected to one or more of the plurality of touch wires.

4. The array substrate according to claim 1, further comprising:
a metal gasket arranged on the first flat layer and in a same layer with the touch wires;
a first via hole passing through the first flat layer arranged above a drain of a thin film transistor, wherein the metal gasket is connected to the drain of the thin film transistor through the first via hole; and
a second via hole passing through the second flat layer arranged above the metal gasket, wherein the pixel electrode layer is connected to the metal gasket through the second via hole.

5. The array substrate according to claim 1, wherein the first flat layer and the second flat layer each are made of an organic film material.

6. The array substrate according to claim 4, wherein a projection of the first via hole onto the array substrate is overlapped with a projection of the second via hole onto the array substrate.

7. The array substrate according to claim 4, wherein a projection of the first via hole onto the array substrate is staggered with respect to a projection of the second via hole onto the array substrate.

8. The array substrate according to claim 1, wherein the thin film transistor further comprises an active layer made of amorphous silicon or low temperature polysilicon.

9. The array substrate according to claim 1, further comprising: a second insulating layer arranged between the first flat layer and the data line layer.

10. The array substrate according to claim 2, wherein a third via hole passing through the first flat layer and the second flat layer is arranged above a drain of a thin film transistor, and the pixel electrode layer is connected to the drain of the thin film transistor through the third via hole.

11. The array substrate according to claim 1, wherein the first flat layer has a thickness in a range between 0.5 μm and 6 μm.

12. The array substrate according to claim 1, wherein the second flat layer has a thickness in a range between 0.5 μm and 6 μm.

13. A liquid crystal display panel, comprising an array substrate, wherein the array substrate comprises:
a plurality of thin film transistors, each of the plurality of thin film transistors comprising a gate, a source and a drain;
a first flat layer on the plurality of thin film transistors;
a touch wire layer on the first flat layer and comprising a plurality of touch wires;
a second flat layer on the touch wire layer;
a color film substrate arranged opposite to the array substrate; and
a liquid crystal layer arranged between the array substrate and the color film substrate.

14. The liquid crystal display panel according to claim 13, wherein the array substrate further comprises: a first insulating layer, a pixel electrode layer, and a common electrode layer,
wherein the common electrode layer is arranged on the second flat layer and comprises a plurality of touch electrodes independent of each other, and each of the plurality of touch electrodes is connected to one or more of the plurality of touch wires;
the first insulating layer is arranged on the common electrode layer; and
the pixel electrode layer is arranged on the first insulating layer.

15. The liquid crystal display panel according to claim 13, wherein the array substrate further comprises: a first insulating layer, a pixel electrode layer, and a common electrode layer,
wherein the pixel electrode layer is arranged on the second flat layer;
the first insulating layer is arranged on the pixel electrode layer; and
the common electrode layer is arranged on the first insulating layer and comprises a plurality of independent touch electrodes, each of the plurality of touch electrodes being connected to one or more of the plurality of touch wires.

16. The liquid crystal display panel according to claim 13, wherein the array substrate further comprises:
a metal gasket arranged on the first flat layer and in a same layer with the touch wires;
a first via hole passing through the first flat layer arranged above a drain of a thin film transistor, wherein the metal gasket is connected to the drain of the thin film transistor through the first via hole; and
a second via hole passing through the second flat layer arranged above the metal gasket, wherein the pixel electrode layer is connected to the metal gasket through the second via hole.

17. The liquid crystal display panel according to claim 13, wherein the first flat layer and the second flat layer each are made of an organic film material.

18. The liquid crystal display panel according to claim 13, wherein the array substrate further comprises a second insulating layer arranged between the first flat layer and the data line layer.

19. The liquid crystal display panel according to claim 14, wherein a third via hole passing through the first flat layer and the second flat layer is arranged above the drain of the thin film transistor, and the pixel electrode layer is connected to the drain of the thin film transistor through the third via hole.

20. The liquid crystal display panel according to claim 13, wherein the first flat layer has a thickness in a range between 0.5 μm and 6 μm, and the second flat layer has a thickness in a range between 0.5 μm and 6 μm.
